(19) United States
(12) Patent Application Publication
(10) Pub. No.: US 2006/0252449 A1
(43) Pub. Date: Nov. 9, 2006

(54) Methods and apparatus to provide adaptive power save delivery modes in wireless local area networks (LANs)

(76) Inventor: Sridhar Ramesh, Bangalore (IN)

Correspondence Address: TEXAS INSTRUMENTS INCORPORATED, P O BOX 655474, M/S 3999, DALLAS, TX, 75265, US

(21) Appl. No.: 11/411,527

(22) Filed: Apr. 26, 2006

Related U.S. Application Data
(60) Provisional application No. 60/675,266, filed on Apr. 26, 2005.

(51) Int. Cl. H04B 7/00

(52) U.S. Cl. 455/522

(57) ABSTRACT

Methods and apparatus of regulating power of a station in a wireless local area network are disclosed. The station is in wireless communication with an access point. A downlink frame is sent to the station. The downlink frame includes an uplink offset time which is the time until an uplink transmission is sent to the access point. The station is placed in a low power mode for the offset time.

### RELATED APPLICATIONS

This application claims benefit of Provisional Application No. U.S. 60/675,266 filed Apr. 26, 2005.

### FIELD OF THE DISCLOSURE

This disclosure relates generally to wireless local area networks (WLANs) and, more particularly, to methods and apparatus to provide adaptive power save delivery modes in wireless LANs.

### BACKGROUND

Wireless LANs are increasingly utilized as a system for communication between wireless devices in close proximity to each other. For example, the IEEE 802.11 standard has been adopted for the use of wireless local area networks. A station (STA) is any device that contains the functionality of the 802.11 protocol and is the most basic component of the wireless network. A station could be a laptop PC, handheld device, a cellular telephone with Internet connectivity or an access point. Stations may be mobile, portable, or stationary and all stations support the 802.11 station services of authentication, de-authentication, privacy, and data delivery. Stations may communicate with each other or preferably, to increase the range of the LAN, communicate to an access point. Access points provide a local relay point to a network backbone, such as the Internet, for a group of stations termed a basic service set (BSS).

In mobile wireless devices, an important consideration is saving power because mobile wireless devices are typically battery powered. The battery power is limited in energy capacity and the operating time of such devices depends on the amount of energy consumed. In particular, preparation for and transmission of data uses a relatively large amount of power and receiving data also requires power. The IEEE 802.11e amendment to the IEEE 802.11 standard recommends two data delivery modes for support of low power operation in handheld and battery operated devices; scheduled automatic power save delivery (S-APSD) and unscheduled APSD (U-APSD).

In the scheduled APSD mode, the access point sends uplink frames to the stations on a fixed schedule. The station is in low power mode during the scheduled periods of inactivity between frames, but is active when frames are sent according to the schedule. In contrast to scheduled APSD, unscheduled APSD has no schedule, rather a station using U-APSD sends a trigger frame to the access point. The station then sends an uplink frame of data to the access point during an unscheduled service period following the acknowledgement of the trigger frame by the access point. During the unscheduled service period, the station remains awake and at other times the station rests in a low power mode. U-APSD is more energy efficient then S-APSD under low variable bit rate traffic, resulting in longer sleep times. Conversely, S-APSD is more energy efficient than U-APSD for moderate to heavily loaded networks with predictable traffic.

However, neither S-APSD nor U-APSD is entirely optimal. In the case of low traffic, using S-APSD will waste power because stations must be active on the intervals for downlink traffic according to the fixed schedule even if no data is exchanged between the station and access point. Further, S-APSD is inefficient in cases of high bursts of traffic followed by periods of inactivity as S-APSD requires station power up during even the periods of inactivity. Conversely, with high traffic, energy considerations using U-APSD will slow the transmission of data (due to high medium access contention) and the longer times spent waiting results in longer power up times then necessary.

### BRIEF DESCRIPTION OF THE DRAWINGS

FIG. 1 is a block diagram of an example wireless LAN system utilizing an example adaptive data delivery mode for power saving.

FIG. 2 is a block diagram of the access point which uses an example adaptive data delivery mode for power saving.

FIG. 3 is a block diagram of an example station which uses an example adaptive data delivery mode for power saving.

FIG. 4 is a block diagram of an example controller in FIG. 3 for implementing the adaptive data delivery mode for power saving.

FIG. 5 is a flow diagram of the interaction to determine a data delivery mode between the access point and a station in the wireless LAN system in FIG. 1.

FIG. 6 is a block diagram of a direct sequence frame sent between the stations and the access point of the example wireless LAN system of FIG. 1.

FIG. 7 is a diagram of timing sequences for uplink and downlink frames using the example adaptive data delivery mode.

FIGS. 8A-8B are flow diagrams of an example process used by a station in the wireless LAN of FIG. 1 to implement the example adaptive data delivery mode.

FIG. 9 is a flow diagram of an example process used by the access point in the wireless LAN of FIG. 1 to implement the example adaptive data delivery mode.

### DETAILED DESCRIPTION

In general, example methods and apparatus for an adaptive power save mode delivery in wireless LANs are disclosed. An example method of regulating power of a station in a wireless local area network is disclosed. The station is in wireless communication with an access point. A downlink frame is sent to the station, the downlink frame including an uplink offset time. The uplink offset time represents the time until an uplink transmission to the access point. The station is placed in a low power mode for the offset time.

Another example method is for power saving in a station in a wireless local area network. The station supports a low power mode and at least two data delivery modes. The station is in communication with an access point. Network traffic is monitored. A data delivery mode is selected based on the network traffic. The low power mode is activated in accordance with the selected data delivery mode.

Another example method of power management administered by an access point in wireless communication with at least one station is disclosed. The access point and station form a wireless local area network. Network data traffic is monitored. An uplink offset time is determined based on the network data traffic. The uplink offset time represents the time until an uplink frame is transmitted to the station. A downlink frame is sent to the station, the downlink frame including the uplink offset time. An uplink frame is received from the station.

Another example wireless local area network has an access point having a transceiver and a bridge coupled to a network backbone. A station has a transceiver wirelessly coupled to the access point. The access point transmits a downlink frame to the station. The downlink frame includes a data field indicating the offset time until another downlink frame is transmitted from the access point. The station has a low power mode activated based on the offset time.

An example wireless device conserves power. The wireless device has a transceiver to send an uplink frame with a field indicating a first transmission mode to an access point. The transceiver receives a downlink frame from the access point. The downlink frame includes an uplink offset time. The uplink offset time is representative of the time until the next uplink frame is transmitted. A controller puts the wireless device in a low power mode according to the offset time received from the downlink frame.

An example access point for a wireless local area network has a transceiver to receive uplink frames from at least one station. The transceiver transmits downlink frames to the at least one station. A medium access controller is coupled to the transceiver. The medium access controller writes a downlink offset time indicating the time until transmitting a second downlink frame to the station.

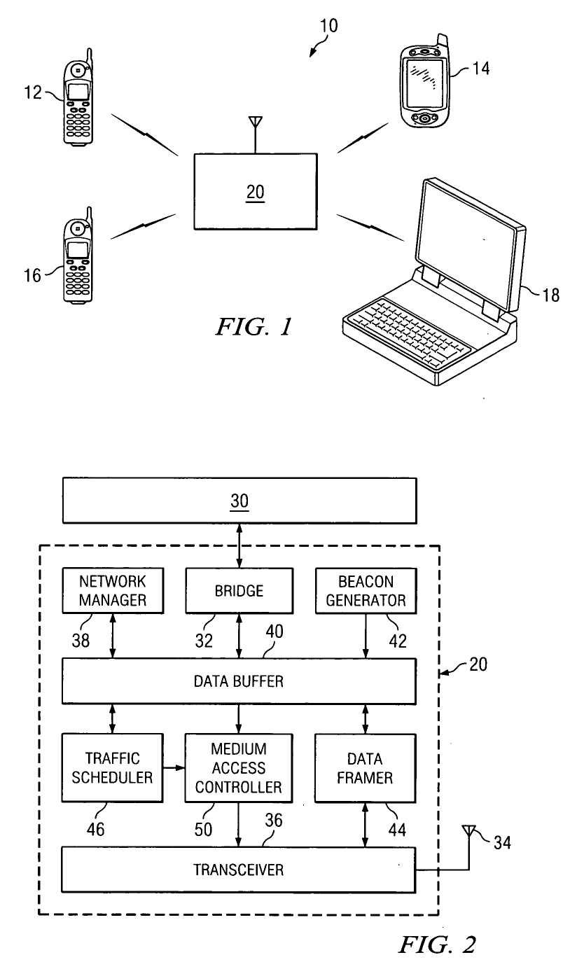

FIG. 1 is a block diagram of an example wireless local area network (WLAN) 10. The WLAN10 has a number of stations 12, 14, 16 and 18 which create a BSS with an access point 20. The stations 12, 14, 16 and 18 may be any wireless device such as for example laptop PC, handheld device, cellular (dual mode) telephone or VoIP (single mode) telephone. The access point 20 communicates with each of the stations 12, 14, 16 and 18 via uplink frames which are sent from the stations 12, 14, 16 and 18 to the access point 20 and downlink frames which are sent from the access point 20 to the stations 12, 14, 16 and 18. Each station 12, 14, 16 and 18 has a power save mode in which the station enters one or more power saving modes (i.e., sleep modes) to conserve power. The power save mode carried out by then stations 12, 14, 16 and 18 is dictated by an adaptive data exchange mode run by the station and the access point 20. The adaptive data exchange mode allows different data delivery modes such as the U-APSD mode, the S-APSD mode, or an example dynamic scheduling data delivery mode to maximize power conservation. As will be explained below, the two components of the example adaptive data exchange mode are: (1) a dynamic scheduling data delivery mode where scheduling information pertaining to the next uplink and downlink times are included in downlink data frames from the access point 20 and (2) a mechanism for signaling whether legacy data delivery mode (U-APSD or S-APSD) or the dynamic scheduling data delivery mode is in effect.

FIG. 2 is a block diagram of an example access point 20 to communicate with the stations 12, 14, 16 and 18 in FIG. 1. The access point 20 may, for example, be implemented by a logic circuit or may be implemented by software and/or firmware executed by a central processing unit (CPU). The access point 20 communicates with a backbone network 30 such as the Internet via a bridge 32. The access point 20 includes an antenna 34 which sends and receives frames to and from stations such as the stations 12, 14, 16 and 18 in FIG. 1. The antenna 34 is coupled to a transceiver 36. The access point 20 includes a network manager 38, a data buffer 40, a beacon generator 42, a data framer 44, a traffic scheduler 46, and a medium access controller 50. The network manager 38 admits various stations into the network following authentication and association procedures. The traffic scheduler 46 schedules the intervals that uplink and downlink frames are sent, and schedules the transmission of uplink and downlink frames in a manner for optimal power conservation which will be explained below. The data buffer 40 temporarily stores data for transmission to the stations or the network 30. The data framer 44 prepares the data for transmission on the frames. The medium access controller 48 prepares the addressing of the frames, delimits the frames and determines when the access point 20 may access the wireless medium for transmission in accordance with the IEEE 802.11 suite of protocols. The beacon generator 42 generates beacon signals which alert potential stations of the presence of the access point 20.

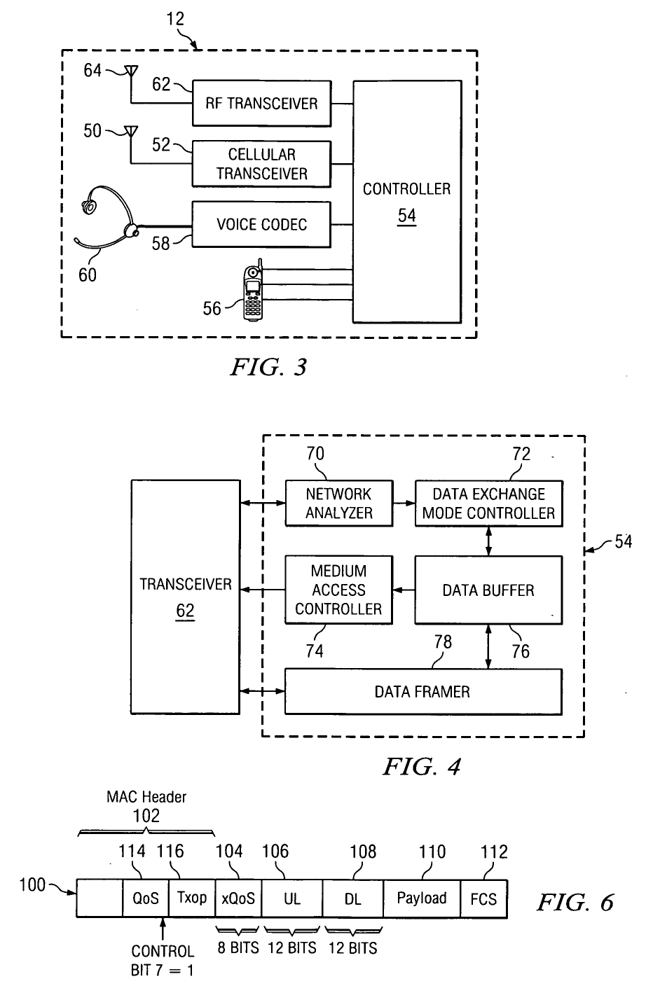

FIG. 3 illustrates an example manner of implementing at least a portion of the station 12 of FIG. 1. The station 12 is a wireless device, which, in this example, is a PDA/cellular telephone. To support wireless communications with a cellular communications network, the example station 12 of FIG. 3 includes any of a variety of a cellular antenna 50 and any of a variety of a cellular transceiver 52. The example antenna 50 and the example cellular transceiver 52 of FIG. 3 are able to receive, demodulate and decode cellular signals transmitted to the station 12 by, for instance, a cellular communications network. Likewise, the cellular transceiver 50 and the cellular antenna 52 are able to encode, modulate and transmit cellular signals from the example station 12 to the cellular communications network.

To process received and decoded signals and to provide data for transmission, the illustrated example station 12 of FIG. 3 includes a control circuit such as a controller 54. In general, the controller 54 controls the functions of the example station 12 of FIG. 3 and/or provides one or more of a variety of user interfaces 56 (e.g. touch screen or keypad), applications, services, functionalities implemented and/or provided by the example station 12 of FIG. 3. The processor 54 also controls the data delivery modes which are explained below.

To provide, for example, telephone services, the example station 12 of FIG. 3 includes any of a variety of voice coder-decoder (codec) 58 and any variety of input and/or output devices such as, for instance, a jack for a headset 60. The handset 60 includes an earpiece for broadcasting voice signals and a microphone for input of voice signals. In particular, the processor 54 can receive a digitized and/or compressed voice signal from the headset 60 via the voice codec 58, and then transmit the digitized and/or compressed voice signal via the cellular transceiver 52 and the antenna 50 to the cellular communications network. Likewise, the controller 54 can receive a digitized and/or compressed voice signal from the cellular base station and output a corresponding analog signal via, for example, the headset 60 for listening by a user.

To support additional or alternative communication services, the example station 12 of FIG. 3 may include any of a variety and/or number of RF antennas 62 and/or RF transceivers 64. An example RF antenna 62 and the example RF transceiver 64 support wireless communications to and from the access point 20 in FIG. 1 including transmitting uplink frames to and receiving downlink frames from the access point 20. Additionally or alternatively, the RF transceiver 64 may support communications based on one or more alternative communication standards and/or protocols. Alternatively, the cellular antenna 50 may be used by the RF transceiver 64. Further, a single transceiver may be used to implement both the cellular transceiver 52 and the RF transceiver 64.

In the illustrated example of FIG. 3, the controller 54 may use the RF transceiver 64 to communicate with, among other devices, such as the access point 20, an RF terminal, etc. For instance, the example RF transceiver 64 of FIG. 3 may be used to enable the example station to connect to the Internet and/or a web server via the access point 20.

Although an example station 12 has been illustrated in FIG. 3, user devices may be implemented using any of a variety of other and/or additional devices, components, circuits, modules, etc. Further, the devices, components, circuits, modules, elements, etc. illustrated in FIG. 3 may be combined, re-arranged, eliminated and/or implemented in any of a variety of ways.

FIG. 4 is a block diagram of the example controller 54 in FIG. 3 to implement the adaptive data delivery modes to choose a data delivery mode for the example station 12. The controller 54 may, for example, be implemented by a logic circuit in communication with or integral to the RF transceiver 62, or may be implemented by software and/or firmware executed by a processor which may be any variety of processor such as, for example, a microprocessor, a microcontroller, a digital signal processor (DSP), an advanced reduced instruction set computing (RISC) machine (ARM) processor, etc. In general, the controller 54 includes a network analyzer 70, a data exchange mode controller 72, a medium access controller 74, a data buffer 76 and a data framer 78.

The network analyzer 70 reads traffic data based on the reception of downlink frames and the transmission of uplink frames from the transceiver 62. The traffic data may include the times between receiving downlink frames from the access point. The data exchange mode controller 72 decides the data exchange mode requested by the station in order to optimize power conservation. The data exchange mode controller 72 also implements the reception of downlink frames and the transmission of uplink frames and the low power modes according to the data exchange mode. The data buffer 76 temporarily stores data for transmission to the stations or the network 30. The data framer 78 prepares the data for transmission on the uplink frames. The medium access controller 74 prepares the addressing of the frames, delimits the frames and determines whether the station has access to the access point 20 for communications.

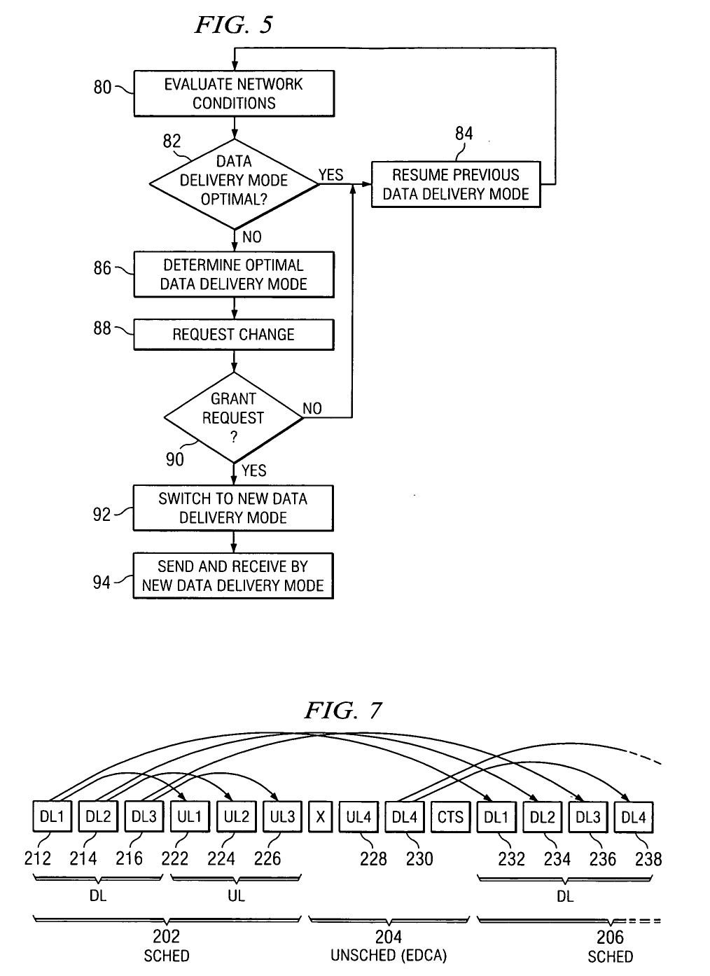

The stations 12, 14, 16 and 18 send uplink frames to the access point 20 and receive downlink frames from the access point 20 in FIG. 1. The data exchange mode determines when the stations 12-18 go into the low power mode and the type of the data exchange mode used by the stations is communicated via the uplink frames to the access point 20. A flow diagram of the determination of the data delivery mode for the WLAN 10 in FIG. 1 is shown in FIG. 5. A station such as the station 12 first evaluates network traffic conditions (block 80) based, for example, on the time between uplink and downlink frame periods. The station then decides whether the current data delivery mode is optimal for the traffic conditions (block 82). If the current data delivery mode is optimal, the station continues with operation according to the current data exchange mode (block 84). If the current data delivery mode is not optimal, the station decides on a desired data delivery mode to optimize data exchange and power conservation (block 86). In this example, the station may opt for one of three data delivery modes: U-APSD, S-ASPD or the example dynamic scheduling automatic power save delivery. The station then requests a change in data delivery mode to the access point 20 (block 88).

On receiving the request, the access point 20 decides whether to grant the request of the station to switch the data delivery mode (block 90). If the request is denied, the station continues with operation under the current data delivery mode (block 84). If the request is granted, the station switches the data delivery mode to the requested mode (block 92). The access point 20 will send and receive uplink and downlink frames with the station according to the new data delivery mode (block 94).

A block diagram of a modified direct sequence data packet 100, which is used for the uplink and downlink frames, is shown in FIG. 6. The data packet 100 has a media access control (MAC) header 102, an extended Quality of Service (xQoS) segment 104 (8 bits in this example), an uplink offset segment 106 (12 bits in this dexample), a downlink offset segment 108 (12 bits in this example), a payload segment 110 and a frame check sequence (FCS) segment 112. In the example data packet 100, the MAC header 102 has a Quality of Service (QoS) field 114 (8 bits in this example) has a bit that signifies a change in the data display mode if the bit is set at 1. The QoS bit is also used to signal the presence of the extended Quality of Service (xQoS) segment 104 in an uplink frame.

In this example, the bit 7 of the QoS field 114 is a reserved bit according to the IEEE 802.11e standard set to 0. In the example system, this bit is set to 1 to signal the presence of 4 bytes of extended data including the extended QoS (xQoS) segment 104, the uplink offset segment 106, and the downlink offset segment 108. Of course, those of ordinary skill in the art will appreciate that other indications and coding schemes may be used to signal the presence of extended data. In this example, bit 7 of the xQoS segment 104 in an uplink frame is set to a logical 0 if legacy power save methods (i.e., S-APSD, U-APSD) are desired by the station. Alternatively, the station can set bit 7 of the xQoS segment 104 to a logical 1 to request dynamic scheduling from the access point 20. The stations 12, 14, 16 and 18 in FIG. 1 use the format of the data packet 100 for uplink communication with the access point 20 and the access point 20 uses the format of the data packet 100 for downlink communication with the stations 12-18. Each example station 12-18 thus may request the type of data delivery mode (i.e., U-APSD, S-APSD or dynamic scheduling) for future uplink and downlink frames in an uplink communication by setting the bits in the QoS field 114 in the media access control segment 102 and the xQoS segment 104 in the data packet 100.

Although, as described above, stations may request a particular type of data delivery mode, the access point 20 may reject such a request by sending downlink frames with both bit 7 of the QoS field 114 set as 0, and the bit 7 of the xQoS control segment 104 set as 0. However, if the access point 20 accepts the request for dynamic scheduling which is explained below, the access point 20 transmits downlink frames with both the control bit of the QoS field 104 and bit 7 of the xQos control segment 104 set to 1. When dynamic scheduling is requested and accepted, in subsequent downlink frames to the requesting station, the access point 20 includes time interval information about the next uplink transmission and downlink reception periods for the station (i.e., the schedule). The media access control segment 102 also includes a transmission opportunity (TXOP) field 116 in bits 8-15. The TxOP field 116 includes the time interval needed to transmit data from the station.

In operation, a station sets up a traffic identifier (TID) and traffic specification for either unscheduled automatic power save delivery (U-APSD) or scheduled automatic power save delivery (S-APSD) depending on the anticipated volume of data traffic. In the case of S-APSD, the station accesses the medium according to the fixed schedule set up by the access point 20 and powers up on schedule. Using S-APSD, at all times when no downlink or uplink frames are scheduled, the station is in power save mode. In the case of U-APSD, the station accesses the medium by using enhanced distributed channel access (EDCA) to send a trigger frame to the access point 20. The station does not power up until the trigger frame is ready for transmission and thereafter remains powered up until receiving a downlink frame instructing the station that no further downlink frames will follow from the access point 20. When the station is using U-APSD, it measures the medium access delay or access point response time. If the time or delay is high, the station will trigger a different type of data delivery mode (e.g., S-APSD or dynamic scheduling) to maximize power saving depending on the traffic. The station will send an uplink quality of service (QoS) data frame using enhanced distributed channel access (EDCA). As explained above, the control bit 7 of the QoS field 114 will be set to 1 to trigger the new power saving delivery mode.

FIG. 7 shows a timing diagram of the uplink and downlink frames in a system with an access point and four stations such as in FIG. 1. In the example of FIG. 7, initially three of the stations 12, 14 and 16 in FIG. 1 are in dynamic scheduling mode for the transmission of uplink and downlink frames. The access point 20 sets the scheduling times of uplink and downlink frames to all stations which are operating in the dynamic scheduling mode. The access point 26 changes the times which are allocated between uplink and downlink frames for these stations depending on the network traffic observed by the access point 20 and network traffic information from the stations. The traffic scheduler 46 in FIG. 2 then sets the scheduling for the downlink and uplink frames. Data on the next scheduled offset times for downlink and uplink period is determined by the traffic scheduler 46 and written into the downlink frame by the medium access controller 48. The offset times in the dynamic scheduling for the next uplink and downlink periods are communicated to the stations via the uplink offset frame 106 and the downlink offset frame 108 in the data packet 100.

In the example in FIG. 7, a first scheduled time period 202 is followed by an unscheduled time period 204 and a second scheduled time period 206. The interval of the second scheduled time period 206 after the first scheduled time period 202 is determined by the access point 20 as a function of network traffic and thus is not on a fixed schedule. The access point 20 sends downlink frames 212, 214 and 216 (DL1, DL2, DL3) to the respective stations 12, 14 and 16. The downlink frames 212, 214 and 216 include the next uplink and downlink time in their respective uplink offset segments and downlink offset segments. In this example, the next uplink time is during the scheduled time period 202 and, thus, each station 12, 14 and 16 sends a respective uplink frame 222, 224 and 226 to the access point 20 according to the time from the downlink frames 212, 214 and 216. Each of the three stations 12, 14 and 16 thus go into power saving mode and power up according to the next uplink or downlink time set by the access point 20.

In this example, a fourth station such as the station 18 in FIG. 1 is initially in the legacy U-APSD mode to conserve power. The station 18 uses EDCA to access the access point 20. Hence, the station 18 sends an uplink frame 228 (UL4) which is designated as a trigger frame in an unscheduled interval 210 before the scheduled period of sending downlink frames 202, 204 and 206. At this time, the station 18 requests to switch to dynamic scheduling by setting the control bit 7 of the QoS field to 1 and bit 7 of the xQoS control segment in the uplink frame 228 (trigger frame) to 1. The access point 20 responds to the trigger frame 228 by sending a delivery enabled downlink frame 230 (DL4). The access point 20 accepts the request for dynamic scheduling. Hence, the downlink frame 230 (DL4) contains information about the times of the next uplink and downlink frames which is read by the station 18.

The access point 20 maintains a schedule for the transmission of uplink frames and the reception of uplink frames by all stations which are set to the dynamic scheduling data delivery mode. On receiving the data frame with the control bit of the QoS field set to 1, the access point 20 adds the sending station 18 to the list of existing stations which are to receive downlink frames (stations 12, 14 and 16 in this example). The access point 20 then schedules uplink and downlink frames for the new station 18 on the next scheduling interval which is the second scheduling interval 206 in this example. From the second interval 206 onwards, the access point 20 includes a downlink frame to the fourth station and thus sends downlink frames 232, 234, 236 and 238 (DL1-DL4) to the respective stations 12, 14, 16 and 18 in the second scheduling interval 206. The information is embedded into the downlink frame by setting bit 7 of the QoS field to 1.

The downlink frames are scheduled together and may be transmitted in a high throughput physical layer (HTP) (PHY) burst. The uplink frames are also scheduled together and may be segregated using inter-frame spacing. Each downlink frame sets the network allocation vector (NAV) to protect the downlink and uplink exchange.

In the dynamic scheduling data delivery mode, a station maintains the power save mode until the next scheduled downlink reception period or uplink transmission period. The offset time to the next scheduled downlink transmission and uplink reception is read by the station from the previous downlink frame received from the access point 20. As explained above, the offset times are adjusted by the access point 20 to optimize power saving and data traffic management. The station sleeps until the next uplink period and transmits an uplink frame to the access point 20. The station then sleeps until the next downlink period and wakes to receive a downlink frame from the access point.

When low traffic load is detected on the WLAN 10 by a station, each station has the ability to switch from and back to a legacy power save operation by setting bit 7 of QoS field and bit 7 of xQoS segment to logical zeros. Thus, an optimal data delivery mode for power saving can always be selected for the prevailing network conditions. For example, under lightly loaded conditions, the station can use unscheduled APSD and derive optimal power saving. When the WLAN 10 becomes more heavily loaded, a station will experience higher wait times to access the medium to send trigger frames and/or higher wait times to receive downlink frames after sending uplink frames, which may result in a station requesting a different data delivery mode from the access point 20. At this time, based on some threshold criterion regarding the network traffic, the station may request a switch to dynamic scheduling or fixed scheduling such as S-APSD. For example, in cases of predictable heavy traffic, a fixed schedule may be most optimal for power saving and, thus, a station could request S-APSD. In cases where bursty traffic is detected, a station could request the dynamic scheduling described above.

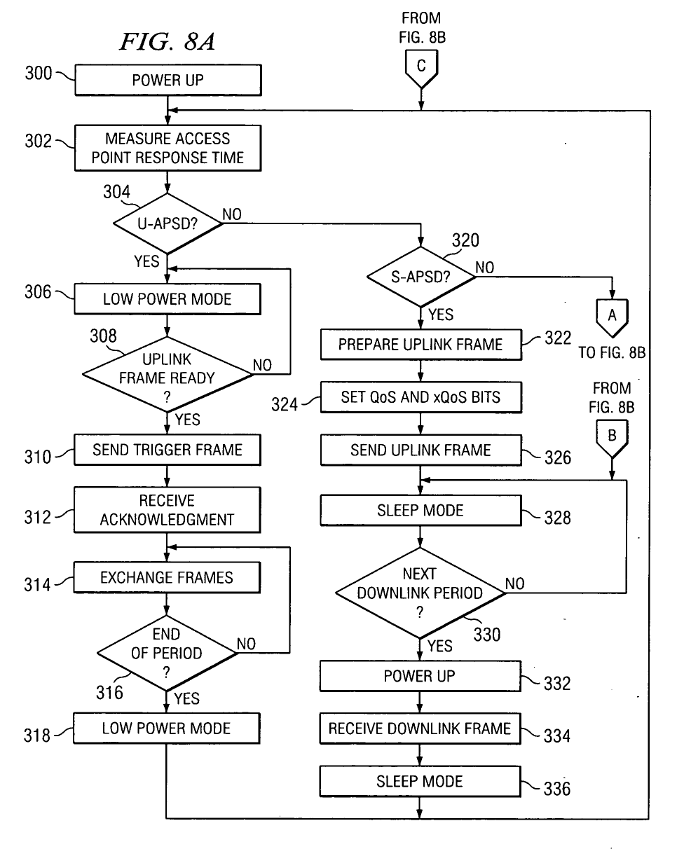

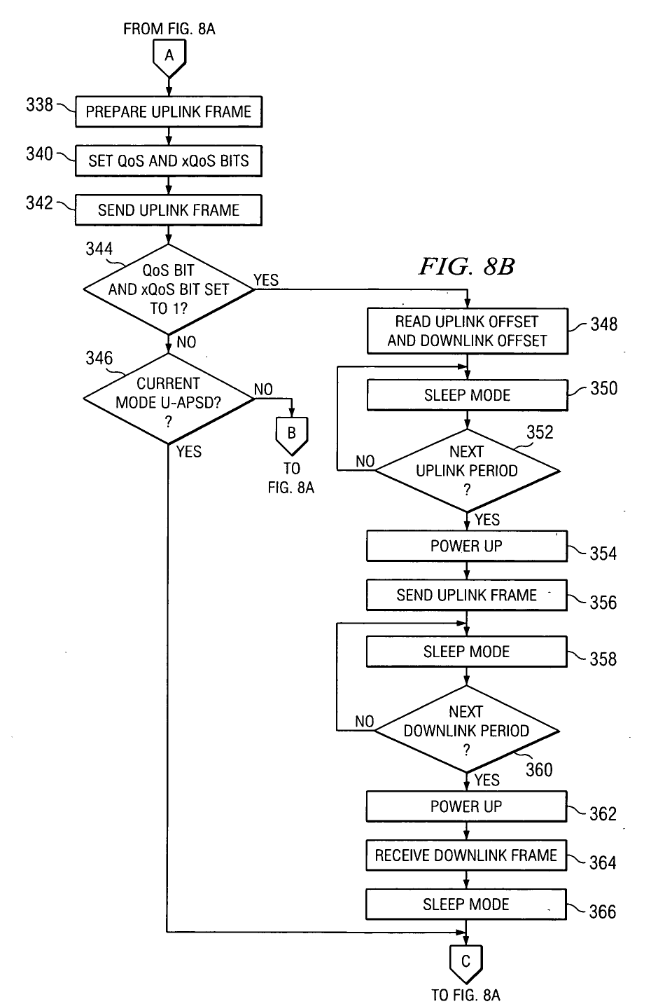

FIGS. 8A-8B are flow diagrams of the logic used by the controller 54 of an example station in FIGS. 3-4 to change the power saving mode of the station to that of dynamic scheduling. In the example of FIGS. 8A-8B, the station powers up in the U-APSD mode (block 300). The network analyzer 70 measures network response times (block 302). The data exchange mode controller 72 determines whether the network response time makes the U-APSD mode appropriate (block 304). In this example, the determination of network response times indicate whether the U-APSD or S-APSD mode is the most efficient for power saving or whether dynamic scheduling should be used. Those of ordinary skill in the art will appreciate that there can be numerous algorithms to determine when a station should switch data delivery modes to the U-APSD, S-APSD or dynamic scheduling mode in order to maximize power conservation. Other modes of data delivery may also be chosen.

If the network response time makes the U-APSD mode appropriate (block 304), the station resumes use of the U-APSD data delivery mode and the station is placed in low power mode (block 306). The station periodically determines whether an uplink frame is ready for transmission (block 308). If an uplink frame is not ready, the station continues to sleep (block 306). If an uplink frame is ready, the station sends a trigger frame to the access point 20 (block 310). After receiving an acknowledgment from the access point 20 (block 312), the data exchange mode controller 72 keeps the station awake to transmit uplink frames to the access point 20 and receive downlink frames (block 314). The data exchange mode controller 72 checks the downlink frames to determine whether an end of service data bit has been set to indicate the unscheduled period is over (block 316). If the period is not over, the data exchange mode controller resumes transmitting and receiving frames (block 314). If the period is over, the data exchange mode controller 72 places the station in low power mode (block 318) and returns to monitoring traffic conditions (block 302).

If the network response time indicates use of the U-APSD is not optimal (block 304), the data exchange mode controller 72 determines whether S-APSD or dynamic scheduling is optimal for the network conditions (block 320). If the S-APSD data delivery mode is optimal, the data exchange mode controller 72 sends an ADDTS message to the access point 20 indicating that S-APSD is desired and thereon waits for the ADDTS response indicating the static schedule. If dynamic scheduling is desired, the station prepares an uplink frame (block 322). The data exchange mode controller 72 sets the bit 7 of the QoS field in the MAC header segment to 1 and bit 7 of the xQoS segment to 0 in the uplink frame (block 324). The data exchange mode controller 72 then sends the uplink frame to the access point 20 (block 326).

The data exchange mode controller 72 places the station in a low power mode such as a sleep mode (block 328). The data exchange mode controller 72 periodically determines whether the next fixed scheduled downlink period has occurred (block 330). If the next fixed scheduled downlink period has not occurred, the station remains in sleep mode (block 328). If the next fixed scheduled downlink period has occurred, the data exchange mode controller 72 powers up the station (block 332). The station then receives a downlink frame from the access point 20 (block 334). The data exchange mode controller 72 then places the station in a sleep mode (block 336). The data exchange mode controller 72 continues to monitor network conditions (block 302).

If the data exchange mode controller 72 determines that the S-APSD is not optimal (block 320), the data exchange mode controller 72 will request dynamic scheduling. The data exchange mode controller 72 prepares an uplink frame for transmission when the uplink schedule allows (block 338). The data exchange mode controller 72 sets the QoS bit 7 in the MAC segment to 1 and bit 7 of the xQoS segment to 1 of the uplink frame (block 340). The data exchange mode controller 72 then sends the uplink frame (block 342) via the transceiver 62 to the access point 20.

The station then receives a downlink frame from the access point 20 via the transceiver 62 and reads bit 7 of the QoS field in the MAC segment and bit 7 of the xQoS segment in the downlink frame and determines whether both are set to 1 (block 342). If either bit is not set to 1, the data exchange mode controller 72 determines whether the current data delivery mode is U-APSD (block 344). If the mode is U-APSD, the data exchange mode controller 72 maintains the U-APSD and continues to monitor network response time (block 300). If the current data delivery mode is S-APSD, the data exchange mode controller 72 puts the station in sleep (block 328) until the next scheduled downlink period.

If bit 7 of the QoS field and bit 7 of the xQoS field are set to 1, the data exchange mode controller 72 reads the uplink offset segment and the downlink offset segment of the downlink frame to determine the time intervals until the next uplink frame period and the next downlink frame period (block 346). The data exchange mode controller 72 then places the station in sleep mode (block 348). The data exchange mode controller 72 periodically checks to determine if the time interval until the next uplink period has expired (block 350). If the time period hasn't expired, the station continues to sleep (block 348).

If the time period has expired (block 350), the data exchange mode controller 72 powers up the station (block 352). The data exchange mode controller 72 then prepares an uplink frame and sends the uplink frame via the RF transceiver 62 to the access point 20 (block 354). The data exchange mode controller 72 then places the station in sleep mode (block 356). The data exchange mode controller 72 periodically checks to determine if the time interval until the next downlink period has expired (block 358). If the time period has not expired, the station continues to sleep (block 356)

If the time period has expired (block 358), the data exchange mode controller 72 powers up the station (block 360). The RF transceiver 62 then receives a downlink frame from the access point 20 (block 362). The data exchange mode controller 72 then places the station in sleep mode (block 364). The data exchange mode controller 72 continues to monitor network conditions (304) to determine if a change to another data delivery mode is appropriate.

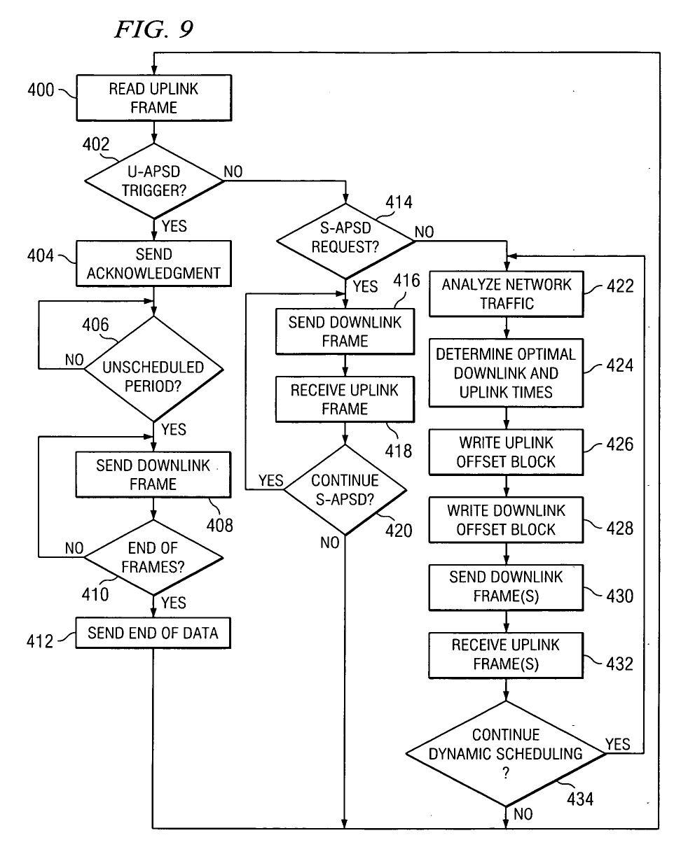

The dynamic scheduling (blocks 346-364) allows the access point 20 to adjust the intervals between uplink and downlink frames to be shorter for the bursts of greater traffic and longer intervals during other times. The access point 20 may monitor the network traffic by reading the TxOP request field in the uplink frames it receives from the stations and make adjustments to future intervals between the next uplink and downlink frame times. FIG. 9 is a flow diagram of the logic used by the example access point 20 in FIG. 2 to manage power conservation of a station or multiple stations such as the stations 12, 14, 16 and 18 using the adaptive data delivery mode.

In this example, the media access controller 48 first reads an uplink frame received by the transceiver 36 (block 400). The media access controller 48 reads the TxOP request in the uplink frame (block 400) to determine network traffic conditions. The media access controller 48 determines whether a U-APSD request is made by determining whether a trigger frame has been received (block 402). If the trigger frame has been received, the media access controller 48 will send an acknowledgment signal to the station via the transceiver 36 (block 404). The media access controller 48 will then determine whether the medium is available (block 406). If the medium is busy, the media access controller 48 will continue to monitor for the occurrence of an unscheduled period. If an unscheduled period is available, the media access controller 48 will send a downlink frame via the transceiver 36 (block 408). The medium access controller 48 will then determine whether the end of the data frames has been reached (block 410). If the end of the frames has not been reached, the medium access controller 48 will continue to have the transceiver 36 send downlink frames (block 408). If the end of the frames has been reached, the medium access controller 48 sends a downlink frame with an end of data field set and the station will be placed in sleep mode (block 410). The medium access controller 48 will then return to reading the next uplink frame (block 400).

If the uplink frame does not contain a U-APSD frame (block 402), in this example, if bit 7 of the QoS field in the MAC header segment is set to 1, the medium access controller 48 will determine if the uplink frame is making an S-APSD request. In this example, the network manager determines if the data delivery mode is S-APSD by reading bit 7 of the QoS bit. If the bit is set to 0, the medium access controller 48 will send a downlink frame (block 416) on the next downlink period in the fixed schedule. The network manager 38 will then receive the next uplink frame from the station based on the next uplink period in the fixed schedule. The medium access controller 48 then determines whether the station will continue use of the S-APSD mode (block 420). If the station continues use of the S-APSD, the medium access controller 48 will send the next downlink frame in the next scheduled downlink period (block 416). If the station is switching away from S-APSD, the medium access controller 48 reads the uplink frame for the new mode (block 400).

If the station has requested the dynamic scheduling data delivery by setting bit 7 of the QoS field to 1 and bit 7 of the xQoS field to 1 (block 414), the traffic scheduler 46 analyzes network traffic by the data in the TxOP field in the uplink frames received from a station or stations (block 422). Those of ordinary skill in the art will appreciate that many different criteria may be used to determine network traffic such as traffic data from a set number of previous uplink frames. The traffic scheduler 46 will then determine the time intervals until the next uplink and downlink periods based on the traffic data (block 424). For example, if the traffic is high indicating a bursty data flow, the traffic scheduler will set the time intervals relatively short to accommodate the greater data traffic. If the traffic is low, the traffic scheduler 46 will set the time intervals relatively long to maximize power conservation in the stations. Those of ordinary skill in the art will appreciate that there may be other criteria and processes to adjust the time intervals to optimize data traffic and power conservation.

The traffic scheduler 46 will then send the time intervals to the medium access controller 48 which will then write the time interval until the next uplink period in the uplink offset block of the next downlink frame(s) being sent to the station(s) in the dynamic scheduling mode (block 426). The medium access controller 48 will also write the time interval until the next downlink period in the downlink offset block of the next downlink frame(s) being sent to the station(s) in the dynamic scheduling data delivery mode (block 428).

The access point 20 sends the downlink frame(s) via the transceiver 36 to station(s) in the dynamic scheduling mode at the appropriate time according to the time interval to the downlink period previously sent to the station(s) (block 430). The access point 20 will receive uplink frame(s) for the station(s) at the scheduled uplink period (block 432). The access point 20 then determines whether the station has continued in the dynamic scheduling mode (block 434). If the station has continued the dynamic scheduling mode, the network manager 38 will read the traffic data from the received uplink frame(s) (block 422). If the station has stopped dynamic scheduling, the network manager 38 will then await the next downlink frame (block 400).

From the foregoing, persons of ordinary skill in the art will appreciate that the above disclosed methods and apparatus may be realized within a single device or across two cooperating devices, and could be implemented by software, hardware, and/or firmware to implement the adaptive power mode disclosed herein.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of regulating power of a station in a wireless local area network, the station in wireless communication with an access point, the method comprising:
sending a downlink frame to the station, the downlink frame including an uplink offset time, the uplink offset time representing the time until an uplink transmission to the access point; and
placing the station in a low power mode for the time interval.

2. The method of claim 1 further comprising determining the offset time representing the time until the next uplink transmission based on network traffic conditions.

3. The method of claim 1 further comprising monitoring network traffic and changing to a second data delivery mode of the station according to the monitored network traffic.

4. The method of claim 3 wherein the downlink frame includes a code indicating a change to a second data delivery mode.

5. The method of claim 3 wherein the second data delivery mode is an unscheduled automatic power save delivery (U-APSD) mode.

6. The method of claim 3 wherein the second data delivery mode is a fixed schedule automatic power save delivery (S-APSD) mode.

7. The method of claim 1 wherein the downlink frame includes a downlink offset time representing the time until the next downlink transmission.

8. The method of claim 1 further comprising:
sending a second downlink frame to a second station, the second downlink frame including an second uplink offset time, the second offset time representing the time to an uplink transmission from the second station to the access point;
placing the second station in a low power mode for the second uplink offset time; and
storing a schedule for the uplink offset times.

9. A method for power saving in a station in a wireless local area network, the station having a low power mode and at least two data delivery modes, the station in communication with an access point, the method comprising:
monitoring network traffic;
selecting a data delivery mode based on the network traffic; and
activating the low power mode in accordance with the selected data delivery mode.

10. The method of claim 9 wherein the data delivery mode is an unscheduled automatic power save delivery (U-APSD) mode.

11. The method of claim 9 wherein the data delivery mode is a fixed schedule automatic power save delivery (S-APSD) mode.

12. The method of claim 9 further comprising:
sending an uplink frame with a request to change data delivery mode to the access point; and
wherein the data delivery mode is a dynamic scheduling mode including receiving a downlink frame from the access point, the downlink frame including an uplink offset time; and
placing the station in a low power mode for the uplink offset time.

13. A method of power management administered by an access point in wireless communication with at least one station, the access point and station forming a wireless local area network, the method comprising:
monitoring network data traffic;
determining an uplink offset time based on the network data traffic, the uplink offset time representing the time until an uplink frame is transmitted to the station;
sending a downlink frame to the station, the downlink frame including the uplink offset time; and
receiving an uplink frame from the station.

14. The method of claim 13 further comprising:
determining a downlink offset time based on the network traffic data, the downlink offset time representing the time until a second downlink frame is sent to the station;
sending a second downlink frame to the station after the downlink offset time has elapsed; and
wherein the downlink frame includes the downlink offset time.

15. A wireless local area network comprising:
an access point having a transceiver and a bridge coupled to a network backbone;
a station having a transceiver wirelessly coupled to the access point, the access point to transmit a downlink frame to the station; and
wherein the downlink frame includes a data field indicating the offset time until another downlink frame is transmitted from the access point, and wherein the station has a low power mode activated based on the offset time.

16. The wireless local area network of claim 15 wherein the access point to set the offset time to the next uplink transmission based on network traffic conditions.

17. The wireless local area network of claim 15 wherein the station has a second data delivery mode to control the activation of the low power mode.

18. The wireless local area network of claim 15 wherein the downlink frame includes a code indicating a change to a second data delivery mode to control the activation of the low power mode.

19. The wireless local area network of claim 18 wherein the second data delivery mode is an unscheduled automatic power save delivery (U-APSD) mode.

20. The wireless local area network of claim 18 wherein the second data delivery mode is a fixed schedule automatic power save delivery (S-APSD) mode.

21. The wireless local area network of claim 15 wherein the downlink frame includes a downlink offset time to the next downlink transmission.

22. A wireless device to conserve power, the wireless device comprising:
a transceiver to send an uplink frame with a field indicating a first transmission mode to an access point and to receive a downlink frame from the access point, the downlink frame including an uplink offset time, the uplink offset time representative of the time until the next uplink frame is transmitted; and
a controller to put the wireless device in a low power mode according to the offset time received from the downlink frame.

23. The wireless device of claim 22 further comprising a second data delivery mode to control the activation of the low power mode.

24. The wireless device of claim 22 wherein the downlink frame includes a code indicating a change to a second data delivery mode to control the activation of the low power mode.

25. The wireless device of claim 24 wherein the second data delivery mode is an unscheduled automatic power save delivery (U-APSD) mode.

26. The wireless device of claim 24 wherein the second data delivery mode is a fixed schedule automatic power save delivery (S-APSD) mode.

27. The wireless device of claim 25 wherein the controller measures the traffic of downlink frames and sets the code indicating a change to a second data transmission mode based on the traffic of downlink frames.

28. An access point for a wireless local area network, the access point comprising:
a transceiver to receive uplink frames from at least one station and to transmit downlink frames to the at least one station; and
a medium access controller coupled to the transceiver, the medium access controller to write a downlink offset time indicating the time until transmitting a second downlink frame to the station.

29. The access point of claim 28 wherein the uplink frames include data relating to network traffic and the access point sets the downlink offset time based on the network traffic data.

30. An article of manufacture storing machine readable instructions which, when executed cause a wireless device to:
receive a downlink frame from an access point, the downlink frame including an uplink offset time until an uplink transmission to the access point; and
place the wireless device in a low power mode for the offset time

31. An article of manufacture storing machine readable instructions which, when executed cause an access point wirelessly communicating with at least one station to send a downlink frame including an uplink offset time until an uplink transmission to the access point.

32. The article of manufacture of claim 31 which when executed causes the access point to:
receive an uplink frame including network traffic data; and
wherein the uplink offset time is determined based on the network traffic data.
